(19) United States
(12) Patent Application Publication
(10) Pub. No.: US 2024/0338260 A1
(43) Pub. Date: Oct. 10, 2024

(54) MECHANISM TO DETECT AND SUGGEST MORE EFFICIENT REST API END POINTS

(71) Applicant: Dell Products L.P., Round Rock, TX (US)

(72) Inventors: Paul McSweeney, Cork (IE); Aaron T. Twohig, Rathpeacon (IE); Aidan Hally, Fermoy (IE)

(73) Assignee: Dell Products L.P., Round Rock, TX (US)

(21) Appl. No.: 18/296,512

(22) Filed: Apr. 6, 2023

(51) Int. Cl. G06F 9/54; G06F 11/07

(52) U.S. Cl. CPC G06F 9/54; G06F 11/0772

(57) ABSTRACT

A method, comprising: receiving, at a computing system, a given single-action API call, the given single-action API call being transmitted by a sender, the given single-action API call being associated with a given operation; detecting whether the given single-action API call is part of a burst, wherein detecting whether the given single-action API call is part of the burst includes detecting whether a plurality of single-action API calls that are associated with the given operation have been received from the sender of the given single-action API call in a predetermined time window; when the given single-action API call is part of a burst, generating an error message in response to the given single-action API call and returning the error message to the sender of the given single-action API call; and when the given single-action API call is not part of a burst, executing the given single-action API call.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided, comprising: receiving, at a computing system, a given single-action Application Programming Interface (API) call, the given single-action API call being transmitted by a sender, the given single-action API call being associated with a given operation; detecting whether the given single-action API call is part of a burst of API calls, wherein detecting whether the given single-action API call is part of the burst includes detecting whether a plurality of single-action API calls that are associated with the given operation have been received from the sender of the given single-action API call in a predetermined time window; when the given single-action API call is part of a burst, generating an error message in response to the given single-action API call and returning the error message to the sender of the given single-action API call; and when the given single-action API call is not part of a burst, executing the given single-action API call.

According to aspects of the disclosure, a system is provided, comprising: a memory; and at least one processor that is operatively coupled to the memory, the at least one processor being configured to: receive a given single-action Application Programming Interface (API) call, the given single-action API call being transmitted by a sender, the given single-action API call being associated with a given operation; detect whether the given single-action API call is part of a burst of API calls, wherein detecting whether the given single-action API call is part of the burst includes detecting whether a plurality of single-action API calls that are associated with the given operation have been received from the sender of the given single-action API call in a predetermined time window; when the given single-action API call is part of a burst, generate an error message in response to the given single-action API call and return the error message to the sender of the given single-action API call; and when the given single-action API call is not part of a burst, execute the given single-action API call.

According to aspects of the disclosure, a non-transitory computer-readable medium is provided that stores one or more processor-executable instructions, which, when executed by at least one processor cause the at least one processor to: receive a given single-action Application Programming Interface (API) call, the given single-action API call being transmitted by a sender, the given single-action API call being associated with a given operation; detect whether the given single-action API call is part of a burst of API calls, wherein detecting whether the given single-action API call is part of the burst includes detecting whether a plurality of single-action API calls that are associated with the given operation have been received from the sender of the given single-action API call in a predetermined time window; when the given single-action API call is part of a burst, generate an error message in response to the given single-action API call and return the error message to the sender of the given single-action API call; and when the given single-action API call is not part of a burst, execute the given single-action API call.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2 is a diagram of a first management system and a second management system, according to aspects of the disclosure;

FIG. 3 is a diagram of an example of a database, according to aspects of the disclosure;

FIG. 4 is a flowchart of an example of a process, according to aspects of the disclosure;

FIG. 5 is a flowchart of an example of a process, according to aspects of the disclosure;

FIG. 6 is a flowchart of an example of a process, according to aspects of the disclosure; and

FIG. 7 is a diagram of a computing device, according to aspects of the disclosure.

### DETAILED DESCRIPTION

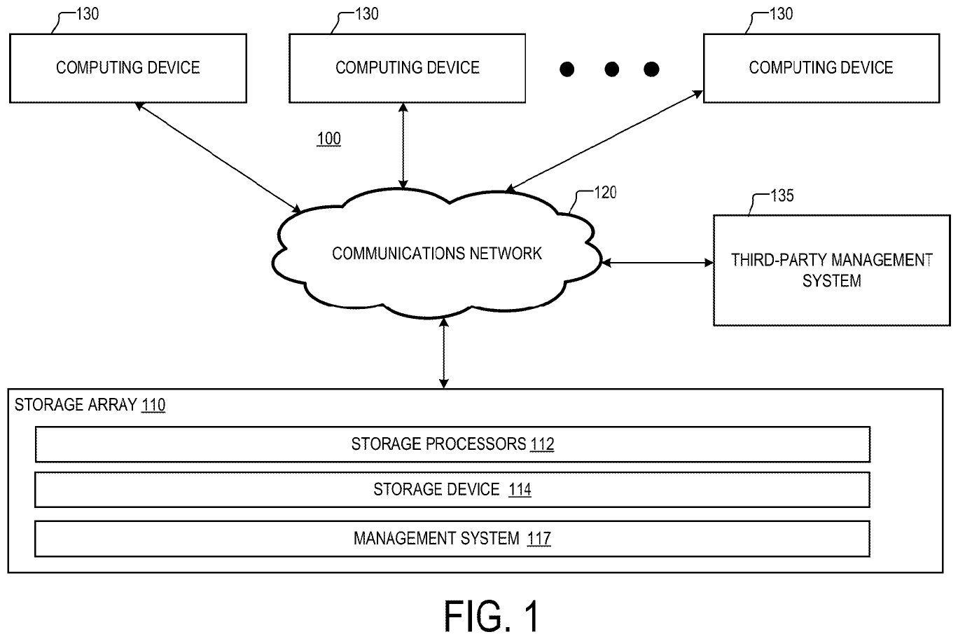

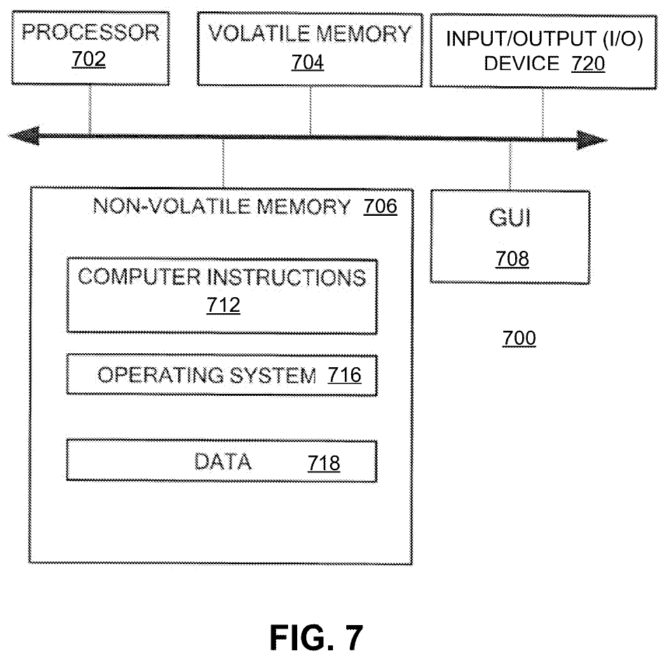

FIG. 1 is a diagram of an example of a system 100, according to aspects of the disclosure. As illustrated, the system 100 may include a storage array 110, a communications network 120, a plurality of computing devices 130, and a third-party management system 135. The communications network 120 may include one or more of a fibre channel (FC) network, the Internet, a local area network (LAN), a wide area network (WAN), and/or any other suitable type of network. The storage array 110 may include a storage system, such as DELL/EMC Powermax™, DELL PowerStore™, and/or any other suitable type of storage system. The storage array 110 may include a plurality of storage processors 112 and a plurality of storage devices 114, and a management system 117. Each of the storage processors 112 may include a computing device, such as the computing device 700, which is discussed further below with respect to FIG. 7. Each of the storage processors 112 may be configured to receive I/O requests from computing devices 130 and execute the received I/O requests by reading and/or writing data to storage devices 114. Each of the storage devices 114 may include one or more of a solid-state drive (SSD), a hard disk (HD), a non-volatile random-access memory (NVRam) device, a non-volatile memory express (NVMe) device, and/or any other suitable type of storage device. The management system 117 may include any suitable type of computing device. The management system 117 may be used by a system administrator to modify various configuration settings and/or otherwise manage storage array 110. Each computing device 130 may include a laptop computer, a desktop computer, an Internet-of-things (IoT) device, and/or any other suitable type of computing device that might read or write data to the storage array 110. The storage processors 112 may be connected to the management system via one or more of a fibre channel (FC) network, the Internet, a local area network (LAN), a wide area network (WAN), and/or any other suitable type of network.

Both the management system 117 and the third-party management system 135 may be used by a system administrator to manage the storage array 110. The difference between the management system 117 and the third-party management system 135 may be that the management system 117 is provided by the vendor of the storage array 110 and the third-party management system 135 is provided by a third-party vendor. The third-party management system 135 may use an Application Programming Interface (API) that is provided by the management system 117 to execute various administrative actions in the storage array 110. The management systems 117 and 135 may connected to each other through the communications network 120 and/or any other suitable type of communications network.

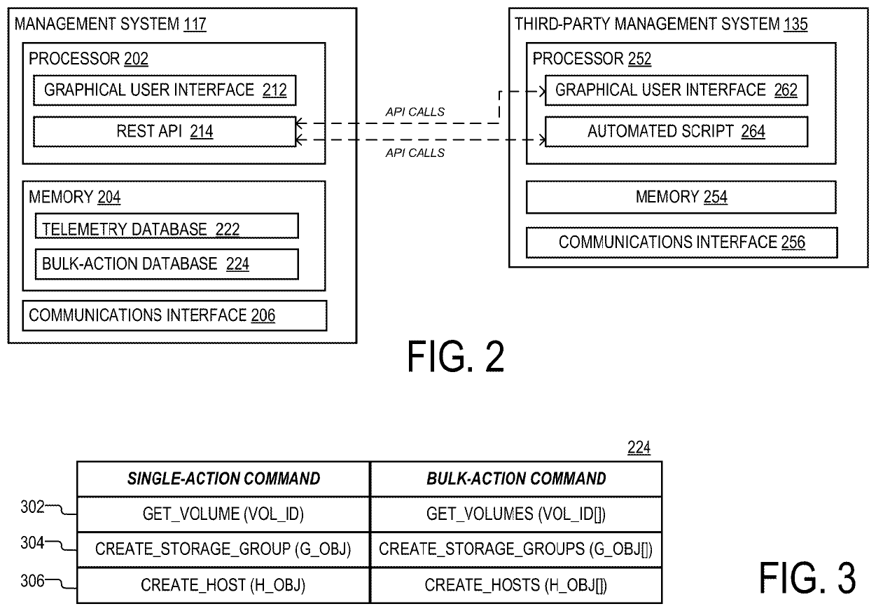

FIG. 2 is a diagram illustrating in further detail the management system 117 and the third-party management system 135, according to aspects of the disclosure.

The management system 117 may include a processor 202, a memory 204, and a communications interface 206. The processor 202 may include one or more of a general-purpose processor (e.g., an x86 processor, an ARM-based processor, etc.), an application-specific integrated circuit (ASIC), a field-programmable gate array (FPGA), and/or any other suitable type of processing circuitry. The memory 204 may include any suitable type of volatile and/or non-volatile memory. The memory 204 may include one or more of a hard drive, a solid-state drive, a dynamic random-access memory (DRAM), and/or any other suitable type of memory. The communications interface 206 may include one or more of an Ethernet adapter, a Bluetooth adapter, a host bus adapter, and/or any other suitable type of communications interface.

The processor 202 may be configured to execute a graphical user interface (GUI) 212 and a REST API 214. The GUI 212 may be configured to receive user input specifying various command parameters and/or commands, which are subsequently executed by the management system 117. The REST API may be configured to provide API calls for executing the same commands that can also be executed through the GUI 212. By way of example, commands that are implemented by various calls of the API 214 include a get_volume command, a create_storage_group command, a create_host command, a get_volumes command, a create_storage_groups command, and a create_hosts command.

The memory 204 may be configured to store a telemetry database 222 and a bulk-action database 224. The database 222 may identify one or more API calls that are received and/or executed by the API 214. For each of the identified API calls, the database 222 may identify one or more of the date and time when the call was received, the sender of the call, the type of the call, and/or any other suitable information. The database 224 may be configured to map each of a plurality of single-action API calls to a corresponding bulk-action API call. The single-action API calls that are identified in the database 224 may be calls provided by the API 214. The bulk-action API calls that are identified in the database 224 may be calls that are provided by the API 214. The database 224 is discussed in further detail with respect to FIG. 3.

As used herein, the term “database” may refer to one or more data structures (e.g., files, records, etc.) that are configured to store information. A database may include a data file, a relational database, such as an SQL database, a non-relational database, and/or any other suitable type of database. Although in the example of FIG. 3 the databases 222 and 224 are depicted as being stored in the memory of the management system 117, it will be understood that alternative implementations are possible in which at least one of the databases 222 and 224 (or a portion thereof) is hosted remotely of the management system 117.

The third-party management system 135 may include a processor 252, a memory 254, and a communications interface 256. The processor 252 may include one or more of a general-purpose processor (e.g., an x86 processor, an ARM-based processor, etc.), an application-specific integrated circuit (ASIC), a field-programmable gate array (FPGA), and/or any other suitable type of processing circuitry. The memory 254 may include any suitable type of volatile and/or non-volatile memory. The memory 254 may include one or more of a hard drive, a solid-state drive, a dynamic random-access memory (DRAM), and/or any other suitable type of memory. The communications interface 256 may include one or more of an Ethernet adapter, a Bluetooth adapter, a host bus adapter, and/or any other suitable type of communications interface.

The processor 252 may be configured to execute a GUI 262 and an automated script 264. The GUI 262 may be configured to receive user input specifying an action and one or more attributes of the action. In response to the user input, the GUI 262 (or an underlying backend) may place an API call with the API 214. The API call may be a call, which when executed by the API 214, causes the management system 117 to execute the action specified by the user, in accordance with the parameters specified by the user. The API 214 may execute the call and return an acknowledgment to the GUI 262 (and/or the management system 135). Alternatively, if the API call cannot be executed, the API 214 may return an error.

The automated script 264 may specify a sequence of API calls. The automated script 264 may be specified by a system administrator and used to configure the storage array 110. The processor 252 may execute the automated script by transmitting each of the API calls that are specified in the script 264 to the API 214. In response to each call, the API 214 may return either an acknowledgment or an error.

FIG. 3 is a diagram of the database 224, according to aspects of the disclosure. As illustrated, the database may include entries 302, 304, and 306. Each of entries 302, 304, and 306 may be configured to map a different one of a plurality of single-action commands to a corresponding bulk-action command.

Entry 302 maps a get_volume (vol_id) command to a get_volumes (vol_id [ ]) command. The get_volume command and the get_volumes commands are calls that are provided by the API 214. The get_volume command is an example of a single-action command. The get_volume command takes a volume identifier as a parameter, and returns an object that represents the volume identified by the volume identifier. The get_volumes command is an example of a bulk-action action command. The get_volumes command takes an array of volume identifiers as a parameter, and returns an array of objects, wherein each of the objects in the array represents a respective volume that is identified by a different one of the identifiers in the array.

Entry 304 maps a create_storage_group (group_object) command to a create_storage_groups (group_object [ ]) command. The create_storage_group and the create_storage_groups commands are API calls that are provided by API 214. The create_storage_group command is an example of a single-action command. The create_storage_group takes a group object as a parameter and creates a storage group having characteristics that are specified by the group object. The create_storage_groups command is an example of a bulk-action action command. The create_storage_groups command takes an array of group objects as a parameter. For each of the group objects in the array, the create_storage_groups command may create a different storage group having the characteristics that are specified by that group object.

Entry 306, maps a create_host (host_object) command to a create_hosts (host_object [ ]) command. The create_host and create_hosts commands are API calls that are provided by API 214. The create_host command is an example of a single-action command. The create_host command takes a host object as a parameter and creates a host having the characteristics specified by the host object. The create_hosts command is an example of a bulk-action action command. The create_hosts command takes an array of host objects as a parameter. For each of the host objects in the array, the create_hosts command may crate a different host having the characteristics specified by the host object.

In one respect, entries 302-306 illustrate the distinction between a single-action command a bulk-action command that corresponds to the single-action command. Specifically, a single-action command may perform a corresponding action once. By contrast, the bulk-action action command which corresponds to the single-action command, may perform the same action many times. Throughout the disclosure, the terms “single-action command” and “single-action API call” are used interchangeably. Throughout the disclosure, the terms “bulk-action command” and “bulk-action API call” are used interchangeably.

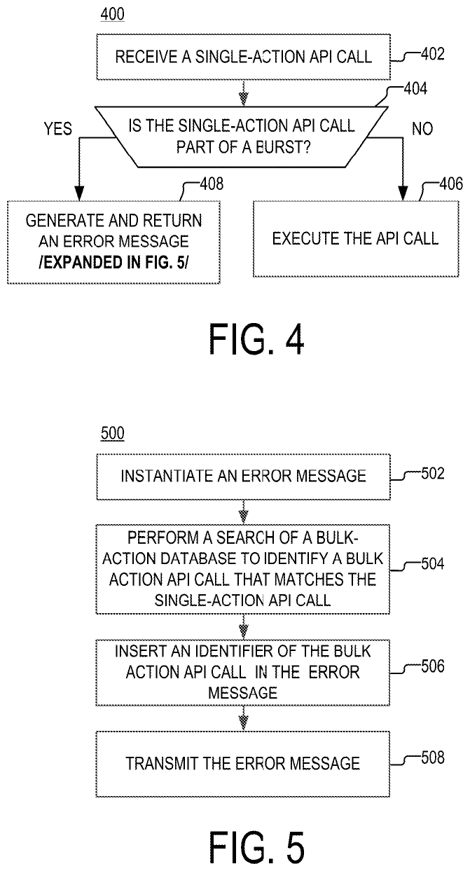

FIG. 4 is a flowchart of an example of a process 400, according to aspects of the disclosure. According to the present example, the process 400 is executed by the management system 117. However, the present disclosure is not limited to any specific entity executing the process 400. At step 402, the management system 117 receives a single-action API call from the third-party management system 135. At step 404, the management system 117 detects whether the single-action API call is part of a burst. If the single-action API call is part of a burst, the process 400 proceeds to step 408. If the single-action API call is not part of a burst, the process 400 proceeds to step 406. At step 406, the management system 117 executes the single-action API call. At step 408, the management system 117 abstains from executing the single-action API call and generates and returns an error message to the sender of the single-action API call (e.g., the third-party management system 135). The error message may indicate that the execution of the single-action API call has failed. In some implementations, step 408 may be performed in accordance with the process 500, which is discussed further below with respect to FIG. 5.

As used herein, the term “burst” refers to a set (or sequence) of single-action API calls that are received within a predetermined time window (e.g., in the past 3 minutes, 10 seconds, 1 second, etc.). In some implementations, for a set of single-action API calls to qualify as a burst, the delay between any two consecutive single-action API calls in the set must be no greater than a predetermined threshold. Additionally or alternatively, in some implementations, for a set of single-action API calls to qualify as a burst, all single-action API calls must be of the same type (e.g., all single-action API calls must be create_host calls, etc.). Additionally or alternatively, in some implementations, for a set of single-action API calls to qualify as a burst, all single-action API calls must be transmitted by the same sender (e.g., by the third-party management system 135, etc.).

In another example, in some implementations, a burst may be a set of calls that are received in quick succession from the same sender. In some implementations, the management system 117 may use the database 222 to determine whether the single-action API call (received at step 402) is part of a burst. As noted above, the database 222 may identify all API calls that are received during a past period (e.g., the last 24 hours, etc.). In this regard, the management system 117 may be used to identify all or some of the API calls that are received by the management system during the predetermined time period (e.g., in the past 3 minutes, etc.) and determine whether the identified API calls (or a subset thereof) qualify as a burst.

Additionally or alternatively, in yet another example, the management system 117 may queue all single-API action calls for a short period of time (e.g., 1 second). The management system 117 may then examine the queued calls to see if they are originating from the same sender and/or otherwise satisfy the conditions necessary to qualify as a burst.

FIG. 5 is a flowchart of an example of a process 500 for generating an returning an error message, as specified by step 408 of the process 400. According to the present example, the process 500 is executed by the management system 117. However, the present disclosure is not limited to any specific entity executing the process 500. At step 502, the management system 117 instantiates an error message. Instantiating the error message may include instantiating a variable or object that represents the error message, and/or reserving memory for the error message. At step 504, the management system 117 performs a search of the database 224 to identify a bulk-action API call that matches the single-action API call received at step 402. In some implementations, a bulk-action API call may match the single-action API call when the bulk-action API performs multiple instances of the same action that is performed by the single-action action API call. Additionally or alternatively, in some implementations, a bulk-action API call matches the single-action API call when both the bulk-action API call and the single-action API call are part of the same entry in the database 224. In some implementations, identifying the bulk-action that matches the single-action API call (received at step 402) may include identifying an entry in the database 224 that includes the single-action API call and retrieving, from the identified entry, an identifier of the bulk-action that is contained in the entry. At step 506, the management system 117 inserts in the error message (instantiated at step 502) an identifier of the bulk-action API call (obtained at step 504). At step 508, the management system 117 transmits the error message to the sender of the single-action API call (received at step 402). According to the present example, the error message is transmitted to the third-party management system 135 (shown in FIG. 1). In one example, the error message (e.g., its payload or header) may include a 503 (Server Busy) HTTP code and the identifier of the bulk-action call may be inserted in the header of the error message. In some implementations, the error message may include a prompt urging the sender of the single-action API call (received at step 402) to use the bulk-action API call (identified at step 504) instead of the burst of single-action API calls. The prompt may include the string of: “Please consider using the identified bulk-action command”.

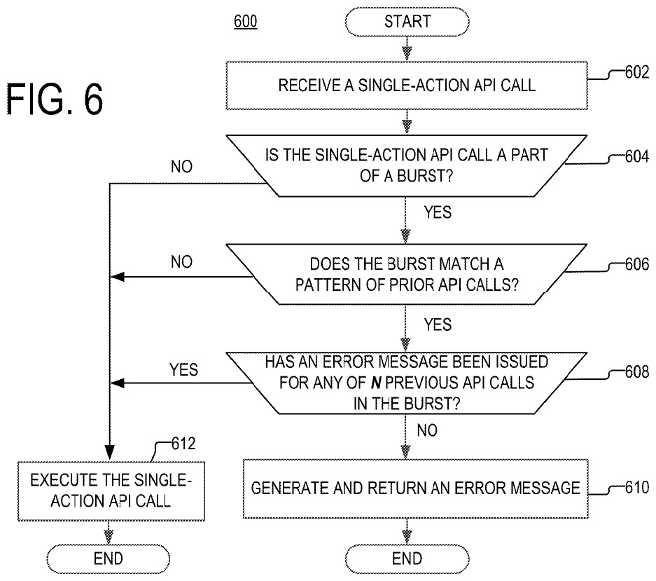

FIG. 6 is a flowchart of an example of a process 600, according to aspects of the disclosure. According to the present example, the process 600 is executed by the management system 117. However, the present disclosure is not limited to any specific entity executing the process 600.

At step 602, the management system 117 receives a single-action API call from the third-party management system 135.

At step 604, the management system 117 determines if the single-action API call is part of a burst. Step 604 may be performed in the same manner as step 404 of the process 400 (shown in FIG. 4). If the single-action API call is part of a burst, the process 600 proceeds to step 606. Otherwise, if the single-action API call is not part of a burst, the process 600 proceeds to step 612. The burst of which the single-action API call is part, and which is identified at step 604, is herein referred to as a “current burst”.

At step 606, the management system 117 detects if the current burst matches a pattern of prior API calls that are received at the management system 117. If the current burst matches a pattern of prior API calls the process 600 proceeds to step 608. Otherwise, if the current burst does not match a pattern of prior API calls, the process 600 proceeds to step 612.

In one example, detecting whether the current burst matches a pattern of prior API calls may include detecting whether the current burst matches a prior burst of single-action API calls, which is received in a predetermined time window. For example, the predetermined time window may start 25 hours before the first single-action API call in the current burst is received and end 1 hour before the first single-action API call in the current burst is received. According to the present disclosure, two bursts may match if they have one or more characteristics in common. For example, two bursts may match if the API calls in them are transmitted by the same sender and/or if the API calls in them are of the same type.

In another example, detecting whether the current burst matches a pattern of prior API calls may include detecting whether a plurality of API calls is received during a predetermined time window, which possess one or more characteristics in common with the API calls in the current burst. The plurality of prior API calls may or may not be part of a burst. In one example, the predetermined time window may start 25 hours before the first single-action API call in the current burst is received and end 1 hour before the first single-action API call in the current burst is received. In one example, the current burst may match a prior pattern of API calls, if a predetermined number of API calls are received from the sender of the single-action API call (received at step 602) during the predetermined time window. In another example, the current burst may match a prior pattern of API calls, if a predetermined number of API calls, from the same type as the single-action API call (obtained at step 602), are received from the sender of the single-action API call during the predetermined time window.

At step 608, the management system 117 detects if an error message has been issued for any of N single-action API calls which are: (i) part of the current burst and (ii) immediately precede the single-action API call (received at step 602). According to the present example, N is a positive integer greater than 1. If an error message has been issued for any of the N preceding single-action API calls, the process 600 proceeds to step 612. Otherwise, the process 600 proceeds to step 610.

At step 610, the management system 117 abstains from executing the API call (received at step 602) and generates and returns an error message. The error message may be returned to the sender of the API call (e.g., the third-party management system 135). Step 610 may be performed in the same manner as step 408 of the process 400 (shown in FIG. 4).

At step 612, the management system 117 executes the single-action API call received at step 402).

An example of the advantages of processes 400-600 is now described in further detail. As noted above, a storage array may provide an API that allows system administrators to use third-party interfaces/clients to perform administrative actions on the storage array. The third-party interfaces/clients may allow the specification and execution of scripts. The scripts may perform large numbers of administrative actions. For example, each script may create hundreds of hosts or get hundreds of volume IDs. A large set of administrative actions may be accomplished by either transmitting a large number of single-action API calls or transmitting a single bulk-action API call. For example, 100 hosts may be created with 100 single-action API calls or by using only one bulk-action call.

The transmission, to the storage array, of a large number of single-action API calls in a quick succession may flood the storage array and make it temporarily unavailable. In other words, the transmission of a large number of single API-calls (at a high rate) may overload the storage array in a way similar to a denial-of-service attack. By contrast, the transmission of a single-action API call may have no effect on the availability of the storage array. For this reason, it is preferable to use bulk-action API calls in place of single-action API calls, whenever possible.

The actions performed by processes 400-600 are intended to discourage system administrators from using single-action API calls in their scripts and encourage them use bulk-action API calls instead. As noted above, they do so by generating an error message in response to a single-action API call that is part of a burst. In one example, any of the error messages may include an identifier of a bulk-action API call that can be used in place of the single-action API call. In another example, any of the error messages may include a prompt urging the system administrator to use the bulk-action API call instead of the burst of single-action API calls. The idea is that a system administrator may investigate failed API calls and notice the prompts in the error logs of the storage array.

In one aspect, error messages may be generated (by processes 400-600) only in response to single-action API calls that are part of a burst. This may ensure that an error message would issue only in response to single-action API calls that are transmitted by a script, such as the script 264 which is shown in FIG. 2. This may further ensure that single-action API calls that are transmitted manually by the user (e.g., by using a GUI such as the GUI 262 which is shown in FIG. 2) would not be interfered with. This is advantageous, because processes 400-600 may seek to modify the types of API calls that are used in scripts by system administrators, rather than impede the sysadmins' interactions with the GUI.

In another aspect, error messages may be generated by the process 600 in response to only a percentage (or portion) of the single-action API calls in a burst. For example, the process 600 may generate an error message in response to every 5^{th} single-action API call in the burst or in response to every 7^{th} single-action API call. This is achieved by the execution of step 608, which is discussed above with respect to FIG. 6.

In another aspect, the error message that is issued in response to any single-action API call may be a Server Busy error message. Using this type of error message will result in a re-transmission of the single-action API call (which was rejected) rather than a seizure of all attempts to execute the API call. Issuing this type of message is advantageous because it may disrupt the execution of a script without halting it completely. This is consistent with the idea to draw the attention of system administrators to the possibility of using bulk-action API calls without completely preventing the execution of scripts that rely heavily on the execution of a large number of single-action API calls.

Referring to FIG. 7, in some embodiments, a computing device 700 may include processor 702, volatile memory 704 (e.g., RAM), non-volatile memory 706 (e.g., a hard disk drive, a solid-state drive such as a flash drive, a hybrid magnetic and solid-state drive, etc.), graphical user interface (GUI) 708 (e.g., a touchscreen, a display, and so forth) and input/output (I/O) device 720 (e.g., a mouse, a keyboard, etc.). Non-volatile memory 706 stores computer instructions 712, an operating system 716 and data 718 such that, for example, the computer instructions 712 are executed by the processor 702 out of volatile memory 704. Program code may be applied to data entered using an input device of GUI 708 or received from I/O device 720.

FIGS. 1-7 are provided as an example only. In some embodiments, the term “I/O request” or simply “I/O” may be used to refer to an input or output request. In some embodiments, an I/O request may refer to a data read or write request. At least some of the steps discussed with respect to FIGS. 1-7 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method, comprising:
receiving, at a computing system, a given single-action Application Programming Interface (API) call, the given single-action API call being transmitted by a sender, the given single-action API call being associated with a given operation;
detecting whether the given single-action API call is part of a burst of API calls, wherein detecting whether the given single-action API call is part of the burst includes detecting whether a plurality of single-action API calls that are associated with the given operation have been received from the sender of the given single-action API call in a predetermined time window;
when the given single-action API call is part of a burst, generating an error message in response to the given single-action API call and returning the error message to the sender of the given single-action API call; and
when the given single-action API call is not part of a burst, executing the given single-action API call.

2. The method of claim 1, further comprising:
comparing the burst to one or more prior patterns of API calls to determine whether the burst matches any of the prior patterns of API calls, each of the prior patterns of API calls being associated with a respective prior time window that precedes the predetermined time window,
wherein the error message is generated and returned only when the burst matches at least one of the prior patterns of API calls, and
the given single-action API call is executed when the given single-action API is part of burst, but the burst does not match any of the prior patterns of API calls.

3. The method of claim 1, wherein:
generating the error message includes identifying a bulk-action API call that corresponds to the given single-action API call, and inserting, in the error message, an identifier of the bulk-action API call,
the given single-action API call is an API call, which, when executed, causes the given operation to be performed once, and
the bulk-action API call that corresponds to the single API call is an API call, which, when executed, causes the given operation to be performed multiple times.

4. The method of claim 1, wherein generating the error message includes inserting in the error message a prompt for a user to use a bulk-action API call instead of the burst of API calls.

5. The method claim 1, further comprising:
when the given single-action API call is part of the burst, detecting whether a respective error message has been returned in response to any of a predetermined number of single-action API calls from the burst that precede the given single-action API call; and
executing the given single-action API call when a respective error message has been returned in response to any of the predetermined number of API calls,
wherein the error message is generated and returned only when none of the predetermined number of single-action API calls have been responded to with an error message.

6. The method of claim 1, wherein detecting whether the given single-action API call is part of the burst further includes detecting whether a time delay between any two consecutive single-action API calls from the plurality is less than a predetermined threshold.

7. The method of claim 1, wherein the error message includes a Server Busy message.

8. A system, comprising:
a memory; and
at least one processor that is operatively coupled to the memory, the at least one processor being configured to:
receive a given single-action Application Programming Interface (API) call, the given single-action API call being transmitted by a sender, the given single-action API call being associated with a given operation;
detect whether the given single-action API call is part of a burst of API calls, wherein detecting whether the given single-action API call is part of the burst includes detecting whether a plurality of single-action API calls that are associated with the given operation have been received from the sender of the given single-action API call in a predetermined time window;
when the given single-action API call is part of a burst, generate an error message in response to the given single-action API call and return the error message to the sender of the given single-action API call; and
when the given single-action API call is not part of a burst, execute the given single-action API call.

9. The system of claim 8, wherein:
the at least one processor is further configured to compare the burst to one or more prior patterns of API calls to determine whether the burst matches any of the prior patterns of API calls, each of the prior patterns of API calls being associated with a respective prior time window that precedes the predetermined time window,
the error message is generated and returned only when the burst matches at least one of the prior patterns of API calls, and
the given single-action API call is executed when the given single-action API is part of burst, but the burst does not match any of the prior patterns of API calls.

10. The system of claim 8, wherein:
generating the error message includes identifying a bulk-action API call that corresponds to the given single-action API call, and inserting, in the error message, an identifier of the bulk-action API call,
the given single-action API call is an API call, which, when executed, causes the given operation to be performed once, and
the bulk-action API call that corresponds to the single API call is an API call, which, when executed, causes the given operation to be performed multiple times.

11. The system of claim 8, wherein generating the error message includes inserting in the error message a prompt for a user to use a bulk-action API call instead of the burst of API calls.

12. The system of claim 8, wherein:
the at least one processor is further configured to: when the given single-action API call is part of the burst, detect whether a respective error message has been returned in response to any of a predetermined number of single-action API calls from the burst that precede the given single-action API call; and execute the given single-action API call when a respective error message has been returned in response to any of the predetermined number of API calls, and
the error message is generated and returned only when none of the predetermined number of single-action API calls have been responded to with an error message.

13. The system of claim 8, wherein detecting whether the given single-action API call is part of the burst further includes detecting whether a time delay between any two consecutive single-action API calls from the plurality is less than a predetermined threshold.

14. The system of claim 8, wherein the error message includes a Server Busy message.

15. A non-transitory computer-readable medium storing one or more processor-executable instructions, which, when executed by at least one processor cause the at least one processor to:
receive a given single-action Application Programming Interface (API) call, the given single-action API call being transmitted by a sender, the given single-action API call being associated with a given operation;
detect whether the given single-action API call is part of a burst of API calls, wherein detecting whether the given single-action API call is part of the burst includes detecting whether a plurality of single-action API calls that are associated with the given operation have been received from the sender of the given single-action API call in a predetermined time window;
when the given single-action API call is part of a burst, generate an error message in response to the given single-action API call and return the error message to the sender of the given single-action API call; and
when the given single-action API call is not part of a burst, execute the given single-action API call.

16. The non-transitory computer-readable medium of claim 15, wherein:
the one or more processor-executable instructions, when executed by the at least one processor, further cause the at least one processor to compare the burst to one or more prior patterns of API calls to determine whether the burst matches any of the prior patterns of API calls, each of the prior patterns of API calls being associated with a respective prior time window that precedes the predetermined time window,
the error message is generated and returned only when the burst matches at least one of the prior patterns of API calls, and
the given single-action API call is executed when the given single-action API is part of burst, but the burst does not match any of the prior patterns of API calls.

17. The non-transitory computer-readable medium of claim 15, wherein:
generating the error message includes identifying a bulk-action API call that corresponds to the given single-action API call, and inserting, in the error message, an identifier of the bulk-action API call,
the given single-action API call is an API call, which, when executed, causes the given operation to be performed once, and
the bulk-action API call that corresponds to the single API call is an API call, which, when executed, causes the given operation to be performed multiple times.

18. The non-transitory computer-readable medium of claim 15, wherein generating the error message includes inserting in the error message a prompt for a user to use a bulk-action API call instead of the burst of API calls.

19. The non-transitory computer-readable medium of claim 15, wherein:
the one or more processor-executable instructions, when executed by the at least one processor, further cause the at least one processor to: when the given single-action API call is part of the burst, detect whether a respective error message has been returned in response to any of a predetermined number of single-action API calls from the burst that precede the given single-action API call; and execute the given single-action API call when a respective error message has been generated in response to any of the predetermined number of API calls, and
the error message is generated and returned only when none of the predetermined number of single-action API calls have been responded to with an error message.

20. The non-transitory computer-readable medium of claim 15, wherein the error message includes a Server Busy message.
